(19) United States
(12) Patent Application Publication
(10) Pub. No.: US 2015/0101206 A1
(43) Pub. Date: Apr. 16, 2015

(54) Adjustable Angle Finder

(71) Applicant: Revolutionary Products, LLC, Farmington Hills, MI (US)

(72) Inventor: H. Sheldon Smith, Elizabeth, CO (US)

(21) Appl. No.: 14/509,639

(22) Filed: Oct. 8, 2014

Related U.S. Application Data
(60) Provisional application No. 61/889,159, filed on Oct. 10, 2013.

(51) Int. Cl. G01B 5/24

(52) U.S. Cl. CPC G01B 5/24
USPC 33/534

(57) ABSTRACT

An adjustable angle finder comprising a first linear arm connected to a second linear arm at a pivot axis. The adjustable angle finder also includes a scale associated with the first linear arm and the second linear arm providing for the display of an angle between the first and second linear arms. In addition, the length of at least one of the first and/or second linear arms is adjustable.

### RELATED APPLICATIONS

This application claims the benefit under 35 USC section 119 of U.S. provisional application 61/889,159 filed on Oct. 10, 2013 and entitled “Adjustable Angle Finder,” the content of which is hereby incorporated by reference in its entirety and for all purposes.

### TECHNICAL FIELD

The embodiments disclosed herein are directed toward an adjustable angle finder and method of using same to determine an angle between two surfaces. The disclosed embodiments are more particularly directed toward an angle finder having two pivotally connected linear arms, where the length of one or both linear arms is adjustable.

### BACKGROUND

Angle finders are used in construction, carpentry and other trades to determine the angle between two surfaces. For example, an angle finder may be used to determine the angle between two walls joined to form an inside or outside corner. The measured angle may then be used to accurately prepare molding, trim or another building material to be attached at the inside corner, outside corner or other junction.

Known angle finders include two arms which pivot with respect to each other such that a flat, linear surface associated with each arm can be placed against a wall or other surface at a corner. A measurement of the angle is read from a gauge on the angle finder. Small irregularities in each wall, for example areas of joint compound, joint tape or corner bead used to smooth the inside or outside corner junction between adjacent drywall sheets, require that a typical angle finder have reasonably long arms to correctly measure the overall angle in the region of a corner or other junction. Many corners however, for example those near a doorway or in the vicinity of a complex corner assembly with multiple services, include obstructions such as doorway molding or a separate wall which prohibit the arms of a typical angle finder from properly being placed against the corner surface. Therefore, it is often necessary to own and use a set of angle finders having arms of greater or lesser length to fit the most commonly encountered restricted spaces.

In addition, many known angle finders have scales or gauges which require mathematical manipulation of the angle values indicated by the scale to determine certain important measurements. Although the mathematical manipulations are not complex, this step can induce error.

The embodiments disclosed herein are directed to overcoming one or more of the problems detailed above.

### SUMMARY OF THE EMBODIMENTS

One embodiment disclosed herein is an adjustable angle finder comprising a first linear arm connected to a second linear arm at a pivot axis. The adjustable angle finder also includes a scale associated with the first linear arm and the second linear arm providing for the display of an angle between the first and second linear arms. In addition, the length of at least one of the first and/or second linear arms is adjustable.

In some embodiments, the length of both the first and second linear arms is adjustable. Arm length adjustment may be accomplished by any suitable means, for example arm length adjustment may be accomplished by selectively disconnecting a removable segment of the first or second linear arm from a remaining segment of the first or second linear arm. In such an embodiment, the connection between the removable segment and the remaining segment may include a male connector terminating either of the segments and a corresponding female socket terminating the opposite segment. The connection can be configured to maintain the linearity of the linear arm when connected.

In certain embodiments, the connection between the removable segment and the remaining segment of the first and/or second arm may be connected or disconnected without the use of tools.

Alternative embodiments include but are not limited to an adjustable angle finder as disclosed herein, a system for determining the angle between two surfaces as disclosed herein or a method of determining the angle between 2 surfaces comprising measuring the angle with an adjustable angle finder as disclosed herein.

### BRIEF DESCRIPTION OF THE DRAWINGS

FIG. 1 is an isometric view of an adjustable angle finder.

FIG. 2 is an exploded isometric view of the adjustable angle finder.

FIG. 3 is a side view of the adjustable angle finder.

FIG. 4 is a front elevation view of the adjustable angle finder.

FIG. 5 is a rear elevation view of the adjustable angle finder.

FIG. 6 is a top view of the adjustable angle finder.

FIG. 7 is a bottom view of the adjustable angle finder.

FIG. 8 a detailed isometric view of the adjustable angle finder.

FIG. 9 is an illustration of the adjustable angle finder in use to measure an inside angle.

FIG. 10 is an illustration of the adjustable angle finder in use to measure an outside angle.

FIG. 11 is an illustration of the adjustable angle finder in use to measure a restricted outside angle.

FIG. 12 is an illustration of the adjustable angle finder in use to measure a restricted inside angle.

FIG. 13 is a detailed front elevation view of the adjustable angle finder.

### DETAILED DESCRIPTION

Unless otherwise indicated, all numbers expressing quantities of ingredients, dimensions, reaction conditions and so forth used in the specification and claims are to be understood as being modified in all instances by the term “about”.

In this application and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

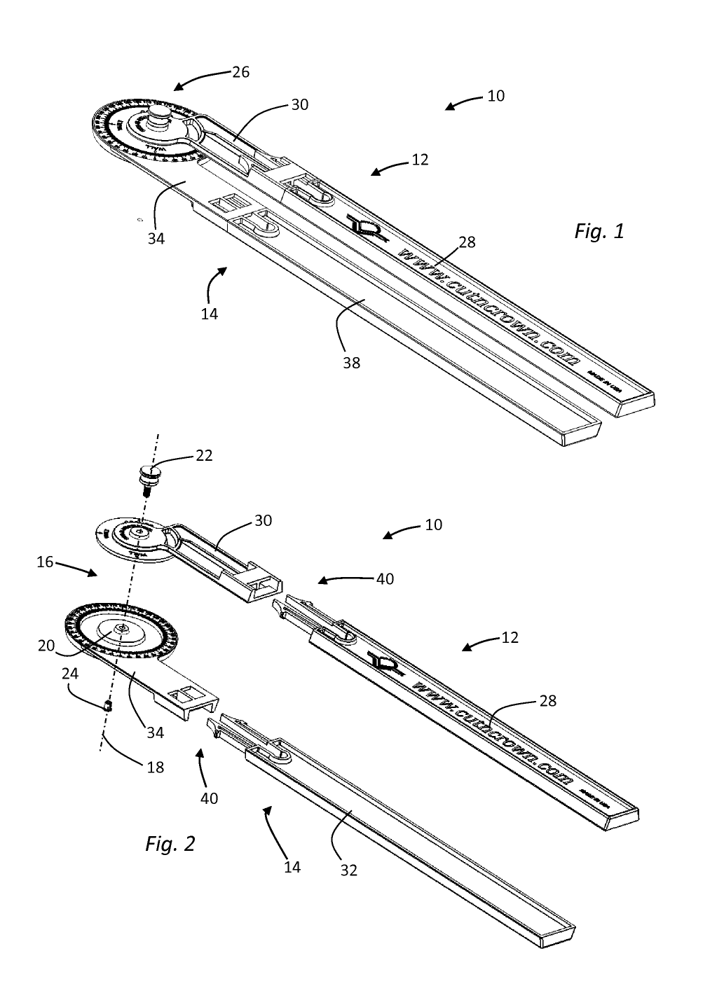

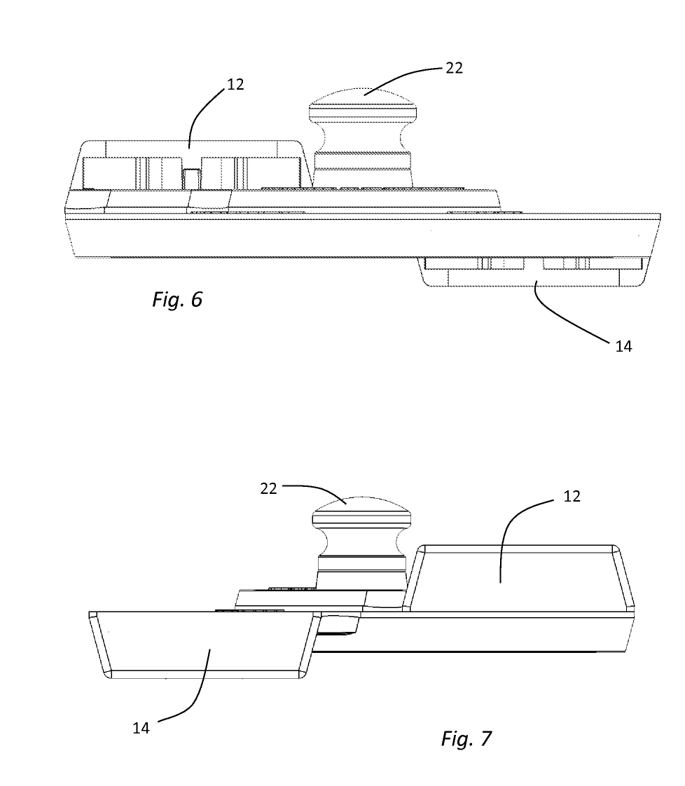

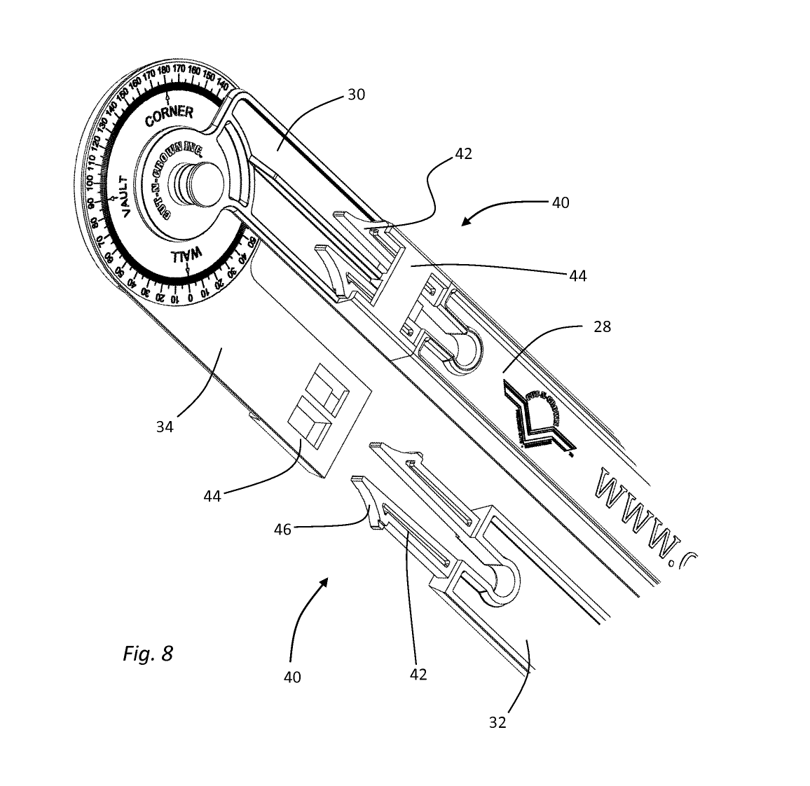

One embodiment disclosed herein is an adjustable angle finder 10 as illustrated in FIGS. 1-13. The adjustable angle finder 10 includes at least two linear arms illustrated in the figures as a first linear arm 12 and a second linear arm 14. The first linear arm 12 and the second linear arm 14 are connected to each other at a pivot 16. The pivot 16 defines a pivot axis 18 which provides for the selective rotation of the first and second linear arms around the pivot axis 18. As best shown in the side view of FIG. 3, the pivot specifically provides for rotation of the first and second linear arms in slightly separated parallel planes such that the arms can be rotated over or past one another.

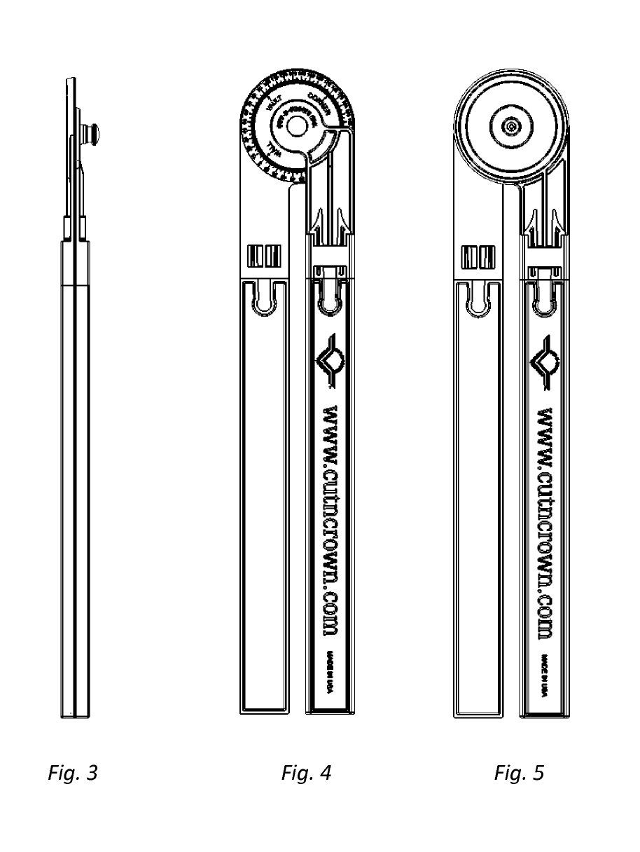

The pivot 16 may be implemented with any suitable structure. For example as shown in FIG. 2 the pivot may include mating bearing surfaces 20, a threaded pivot locking screw 22 and a corresponding threaded nut 24 which may be selectively loosened or tightened to lock or permit rotation of the first and second linear arms with respect to each other.

The adjustable angle finder 10 further includes a scale 26 located at or near the pivot 16. One specific embodiment of a scale 26 and the operation thereof is described in detail below.

All embodiments of the disclosed adjustable angle finder 10 include at least one linear arm which features an adjustable length. In certain embodiments, the length of both arms may be adjusted. As described in detail below, providing the adjustable angle finder 10 with at least one lengthwise adjustable arm gives certain operational advantages. In particular the length of an arm may be adjusted to allow the determination of an angle in an interior or exterior corner where a full-length arm would be obstructed by a wall structure such that the full length arm could not be placed against the proper surface.

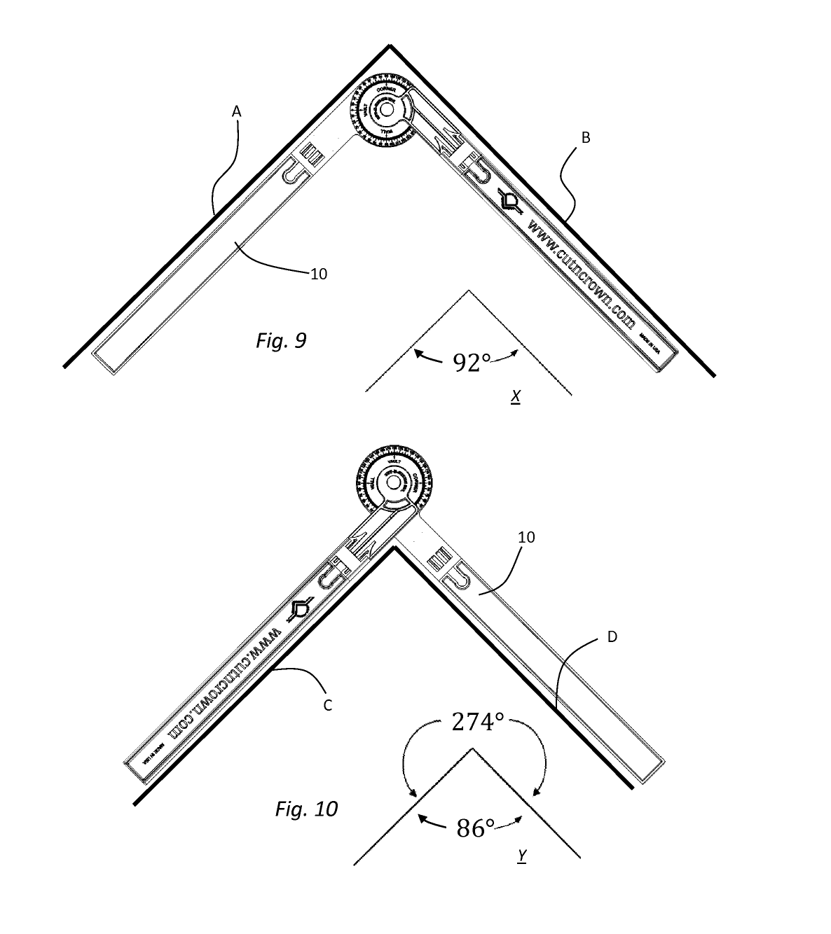

As is best shown in FIG. 2 and FIG. 8, one disclosed type of adjustable arm comprises a removable arm segment and a remaining arm segment. The removable arm segment is located away from the pivot and the remaining arm segment is attached to or co-formed with the pivot structure. Thus, in the embodiment disclosed in FIG. 2 and FIG. 8, the first linear arm comprises a removable arm segment 28 and a remaining arm segment 30 and the second linear arm comprises a removable arm segment 32 and remaining arm segment 34. Therefore, the length of the first linear arm 12 may be substantially shortened by removing the removable arm segment 28 and the length of the second linear arm 14 may be shortened by removing the removable arm segment 32.

As is illustrated in FIG. 9, the adjustable angle finder 10 may be used to measure the inside angle between two faces, walls or other surfaces designated as surfaces A and B. When used to measure an inside angle, the outside surfaces 36 and 38 of the first and second linear arms respectively are placed against surfaces A and B. Is important that each of these outer linear surfaces 36, 38 maintain substantially rigid linearity in use and therefore remain linear across any joint between a removable arm segment and the remaining arm segment. In one embodiment, this functionality is achieved by providing a connection 40 between the removable segment and remaining segment of a given linear arm. In the embodiment shown in the FIGS. 1-13, the connection 40 provided for the first linear arm 12 is identical to the connection 40 provided for the second linear arm 14. The connection 40 comprises a male connector 42 terminating each removable segment 28, 32 and a corresponding female socket 44 terminating each remaining segment 30, 34. In alternative embodiments the male connectors could be associated with the remaining segments and female sockets associated with the removable segments.

The connections 40 include engaging surfaces as illustrated in FIG. 8 which substantially rigidly maintain linearity along the outer linear surfaces 36, 38 of each arm when a removable arm segment is connected to a remaining arm segment. The particular male connectors 42 illustrated in the figures feature curved finger pads 46 which extend through the female socket 44 and which in use may be manually squeezed together to release the male connector 42 from the socket 44 and provide for the removal of a removable arm segment 28, 32 without the use of tools.

As noted above, the linear arms 12 and 14 rotate around the pivot axis 18 in parallel, but slightly separated planes of rotation. Thus the arms may rotate over and past each other allowing the adjustable angle finder tend to be placed in the configuration of FIG. 10 which is suitable for the measurement of an outside corner. A generalized outside corner is illustrated in FIG. 10 as the corner formed by walls or other surfaces C and D. When used to measure an outside corner, the same outer linear surfaces, 36, 38 of linear arms 12 and 14 respectively are placed against the surfaces being measured, although due to the relative positioning of the angle finder arms, these surfaces are on the inside of the angle made between the arms.

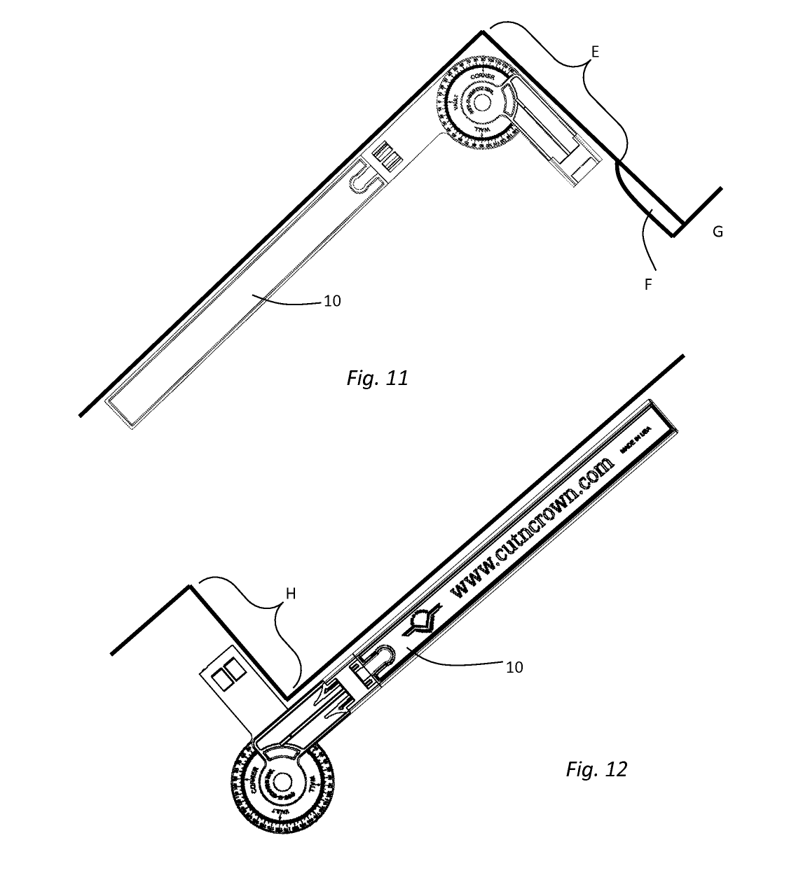

The disclosed embodiments featuring a least one linear arm having an adjustable length provide very specific operational advantages over conventional angle finders. For example, as shown in FIG. 11, an inside corner having a restricted section E can be measured with the adjustable angle gauge 10 by shortening the length of the appropriate linear arm. In FIG. 11 the restricted wall section E is blocked by molding F associated with a doorway G. Any number of similar inside corner restrictions may be encountered in a construction or remodeling project. A restricted wall segment such as E would prohibit the use of a conventional angle finder since a full length arm would not fit in the provided space. This problem has caused builders and carpenters to carry several angle finders in their toolkits with each angle finder having longer or shorter arms. The adjustable angle finder 10 therefore eliminates the need to purchase and carry several angle finders of different sizes. In addition, as shown in FIG. 11 certain corners are only restricted on one side. In such instances, the adjustable angle finder 10 can be configured to utilize the full length arm where permitted thus increasing measurement accuracy.

A similarly restricted wall segment H is illustrated in conjunction with an outside corner measurement in FIG. 12. The restricted segment H may be caused by a compound corner, molding, another structure or otherwise. Providing an adjustable angle finder 10 having at least one arm with an adjustable length permits the accurate measurement of a restricted outside corner without the need to carry multiple sizes of angle finder.

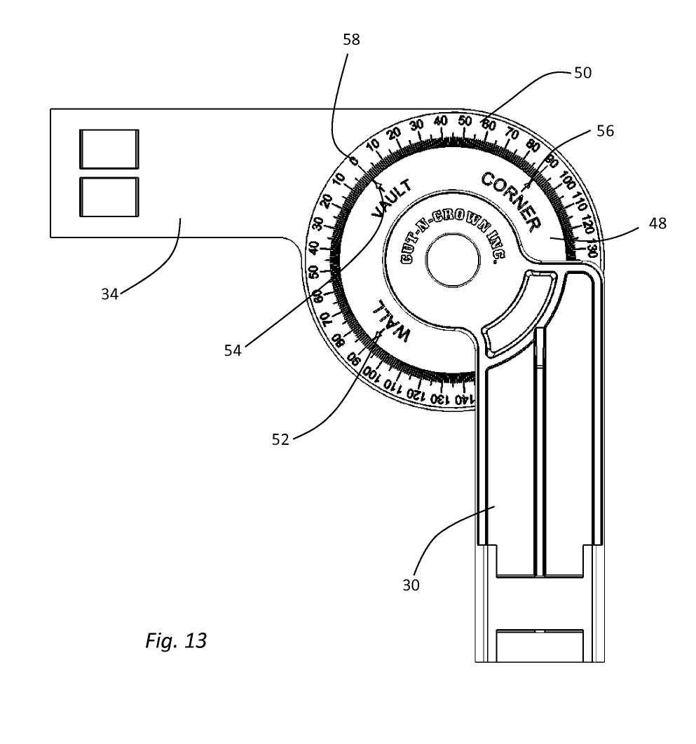

A detailed view of the scale 26 is included in FIG. 13. With reference to FIG. 2, it may be noted that the scale 26 includes an indicator plate 48 and a protractor ring 50. In one embodiment, the indicator plate 48 is co-formed with the remaining segment 30 of the first linear arm 12. Similarly, the protractor ring 50 is co-formed with the remaining segment 34 of the second linear arm 14. Alternative embodiments may be implemented with any other type of substantially rigid joint between each arm and the associated scale elements. Furthermore, the indicator plate 48 and a protractor ring 50 are co-formed with or otherwise associated with the pivot 16 such that the indicator plate may rotate with respect to the protractor ring as the linear arms are rotated with respect to each other.

Alternative embodiments of a scale are within the scope of the present disclosure. For example, an adjustable angle finder 10 could be implemented with an electronic scale featuring sensors and a digital display. Alternatively, various other types of analog scale or different positioning of an analog scale with respect to the pivot might be utilized.

As shown on FIG. 13, the indicator plate 48 includes 3 indicia 52, 54 and 56 respectively. The indicia are labeled “wall” 52, “vault” 54 and “corner “56” in the depicted embodiment although other labels could be utilized. The protractor ring 50 includes a 0 mark (element 58) and graduations 60 which are placed in 1° increments in both a counterclockwise and clockwise direction from 0° at the 0 mark to 180° at the location on the protractor ring 50 opposite the 0 mark.

The indicia and graduations may be used to quickly and accurately read selected angles and associated information and to set selected saw angles when the adjustable angle finder 10 is in use. For example, when measuring an inside corner, such as depicted in FIG. 9 or FIG. 11, the scale 26 is placed directly in the corner and both arms are opened to be flush with the adjoining wall surfaces. The angle formed by the adjoining wall surfaces may be directly read from the protractor ring 50 at the indicator 52 labeled “wall.” Simultaneously, the opposing indicator 56 labeled “corner” directly indicates the total cut angle required for any trim or molding which is to be fit in the corner. The appropriate saw angle settings for making left and right angled cuts maybe quickly determined by dividing the “corner” reading by two.

For example, a hypothetical inside corner (i.e. Corner X of FIG. 9) consists of two walls which meet at an actual 92° angle measured from the first wall to the second wall. When the adjustable angle finder 10 is placed into the corner such that each linear arm is flush with the respective wall, the “wall” indicator 52 will read 92°. The “corner” indicator 56 will read 88°. Therefore, the user of the adjustable angle finder 10 may set a miter saw or similar tool to an angle of 44° (calculated as 88° divided by 2) to quickly and accurately make the left and right angled cuts necessary to precisely fit molding or trim inside the 92° inside corner.

The designations associated with indicia 52, 58 and 56 are not limiting. Other appropriate names or no name at all may be associated with the indicia if desired.

The above described indicia and graduations may also be used in the same manner to quickly and accurately read angles and to set saw angles when the adjustable angle finder 10 is used to measure an outside corner such as depicted in FIG. 10 or FIG. 12. When measuring an outside corner, the adjustable angle finder 10 is placed in the configuration of FIG. 10 with the scale 26 projecting out from the corner. Both arms are opened to be flush with the adjoining wall surfaces. The outside angle formed by the adjoining wall surfaces may be directly read from the protractor ring 50 at the indicator 52 labeled “wall.” Simultaneously, the opposing indicator 56 labeled “corner” directly indicates the total cut angle required for any trim or molding which is to be fit over the outside corner. The respective saw angle settings for making left and right angled cuts maybe quickly determined by dividing the “corner” reading by two.

For example, a hypothetical outside corner consists of two walls which meet at an actual 274° angle (measured from the outside surface of the first wall to the outside surface of the second wall, which corresponds to an 86° angle when measured from the inside surfaces of the walls (i.e. Corner Y of FIG. 9). When the adjustable angle finder 10 is placed over the corner such that each linear arm is flush with the respective wall, the “wall” indicator 52 will read 86°. The “corner” indicator 56 will read 94°. Therefore, the user of the adjustable angle finder 10 may set a miter saw or similar tool to an angle of 47° (calculated as 94° divided by 2) to quickly and accurately make the left and right angled cuts necessary to precisely fit molding or trim over or around the 86° outside corner.

The “vault” indicator 58 measures the vault angle of a ceiling which is defined as the angle at which the ceiling surface rises from horizontal. The unique placement of the “vault” indicator 58 with respect to the protractor ring 50 simplifies this measurement since there is typically not a horizontal surface available from which to take a direct measurement of a vault angle. Therefore, the adjustable angle finder 10 is configured to measure a vault angle with one linear arm placed against an adjacent wall and the other linear arm placed against the ceiling surface with the finder in the configuration of FIG. 9. The location of the vault indicator 58 then directly shows the proper vault angle. For example, the total angle between a vertical wall and a 30° vaulted ceiling is 120°. The proper vault angle of 30° may be directly read from the adjustable angle finder 10 without the need for the simple but time consuming calculations required with prior devices.

The locking screw 22 and associated apparatus provide for the first and second linear arms 12, 14 to be locked at a measured angle such that the adjustable angle finder 10 may be used to directly transfer the measured angle to this a supplemental material, molding for example.

Alternative embodiments disclosed herein are methods of measuring, determining and transferring angles using the adjustable angle finder 10 as described above. Alternative embodiments are toolkits including an adjustable angle finder 10 as described above. Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

While the invention has been particularly shown and described with reference to a number of embodiments, it would be understood by those skilled in the art that changes in the form and details may be made to the various embodiments disclosed herein without departing from the spirit and scope of the invention and that the various embodiments disclosed herein are not intended to act as limitations on the scope of the claims. All references cited herein are incorporated in their entirety by reference.

What is claimed is:

1. An adjustable angle finder comprising:
a first linear arm connected to a second linear arm at a pivot axis providing for the first and second linear arms to be selectively rotated in separated parallel planes around the pivot axis; and
a scale associated with the first linear arm and second linear arm providing for the display of an angle between the first and second linear arms, wherein the length of at least one of the first or second linear arms is adjustable.

2. The adjustable angle finder of claim 1 wherein the length of both the first linear arm and the second linear arm is adjustable.

3. The adjustable angle finder of claim 1 wherein the length of the first or second linear arms is adjustable by selectively disconnecting a removable segment of the first or second linear arm from a remaining segment of the first or second linear arm, wherein the removable segment of the first or second linear arm is located away from the pivot axis.

4. The adjustable finder of claims 1 wherein the length of both of the first and second linear arms are adjustable by selectively disconnecting a removable segment of the first and second linear arms from a remaining segment of the first and second linear arms, wherein the removable segments of the first and second linear arms are located away from the pivot axis.

5. The adjustable angle finder of claim 3 wherein a connection between the removable segment of the first or second linear arm and the remaining segment of the first or second linear arm comprises a male connector terminating one of the removable segment or the remaining segment of the first or second linear arm and a corresponding female socket terminating the corresponding other segment of the first or second linear arm, wherein the connection maintains the linearity of the linear arm when the removable segment and remaining segment are connected.

6. The adjustable angle finder of claim 5 wherein the connection between the removable segment of the first or second arm and the remaining segment of the first or second arm may be connected and disconnected without the use of tools.

7. The adjustable angle finder of claim 1 wherein the scale comprises an indicia plate connected to the first linear arm and a protractor face connected to the second linear arm.

8. The adjustable angle finder of claim 7 wherein the indicia plate comprises multiple indicia separated from each other at selected angles.

9. The adjustable angle finder of claim 7 wherein the indicial plate comprises three indicia separated from each other by 90 degrees.

10. A method of determining the angle between two surfaces comprising:
providing an adjustable angle finder comprising:
a first linear arm connected to a second linear arm at a pivot axis providing for the first and second linear arms to be selectively rotated in separated parallel planes around the pivot axis; and
a scale associated with the first linear arm and second linear arm providing for the display of an angle between the first and second linear arms, wherein the length of at least one of the first or second linear arms is adjustable; and
placing the adjustable angle finder against first and second adjacent planar surfaces which meet at an angle between the first and second planar surface such that the first linear arm contacts one planar surface and the second linear arm contacts the other of the planar surfaces; and
measuring the angle between the first and second planar surfaces from the scale.

11. The method of claim 10 further comprising adjusting the length of the first or second linear arm by selectively disconnecting a removable segment of the first or second linear arm from a remaining segment of the first or second linear arm, which removable segment of the first or second linear arm is located away from the pivot axis.

12. The method of claim 11 further comprising adjusting the length of the first or second linear arm by disconnecting a connection between the removable segment of the first or second linear arm and the remaining segment of the first or second linear arm, wherein said connection comprises a male connector terminating one of the removable segment or the remaining segment of the first or second linear arm and a corresponding female socket terminating the corresponding other segment of the first or second linear arm, and wherein the connection maintains the linearity of the linear arm when the removable segment and remaining segment are connected.

13. The method of claim 12 wherein the connection between the removable segment of the first or second arm and the remaining segment of the first or second arm may be connected and disconnected without the use of tools.

14. The method of claim 10 further comprising:
providing the scale as an indicia plate connected to the first linear arm and a protractor face connected to the second linear arm; and
measuring the angle between the first and second planar surfaces by reading an angle measurement from the protractor face adjacent to an indicia on the indicia plate.

15. The method of claim 14 further comprising:
providing the indicia plate with multiple indicia separated from each other;
measuring the angle between the first and second planar surfaces by reading an angle measurement from the protractor face adjacent to the first indicia on the indicia plate; and
measuring a total miter cut angle required for a trim piece which is to be fit over or into the angle between the first and second planar surfaces by reading an angle measurement from the protractor face adjacent to a second indicia on the indicial plate.

16. The method of claim 14 comprising providing the indicia plate with three indicia separated from each other by 90 degrees.

17. The method of claim 14 wherein the first planar surface is a building wall and the second planar surface is a building ceiling, the method further comprising directly measuring the angle the second planar surface varies from horizontal by reading an angle measurement from the protractor face adjacent to an indicia on the indicia plate.
